(19) United States
(12) Patent Application Publication
(10) Pub. No.: US 2003/0192395 A1
(43) Pub. Date: Oct. 16, 2003

(54) Handle grip cover for use on bicycle

(75) Inventor: Kuo-Chung Hsu, Changhua Hsien (TW)

Correspondence Address: BACON & THOMAS, PLLC, 625 SLATERS LANE, FOURTH FLOOR, ALEXANDRIA, VA, 22314

(73) Assignee: Sunny Wheel Industrial Co., Ltd., Changhua Hsien (TW)

(21) Appl. No.: 10/121,688

(22) Filed: Apr. 15, 2002

(51) Int. Cl. B62K 21/26

(52) U.S. Cl. 74/551.9

(57) ABSTRACT

The present invention relates to a handle grip cover for use on a bicycle, which is an integrally formed elastic hollow body having at one end an engagement opening. On the wall of the hollow body are disposed a plurality of paired vertical through holes perpendicular to the axis of the grip handle whereby a rider of a bicycle can grasp the handles of the bicycle with comfort as a result of shock being easily absorbed by such a hole-filled hollow body. In addition, such handle grip covers are mass produced with ease and speed.

### BACKGROUND OF THE INVENTION

The present invention relates to a handle grip cover for use on a bicycle, which is an integrally formed elastic hollow body having at one end an engagement opening. On the wall of the hollow body are disposed a plurality of parallel paired vertical through holes perpendicular to the axis of the grip handle whereby a rider of a bicycle can grasp the handles of the bicycle with comfort as a result of shock being easily absorbed by such a hole-filled hollow body. In addition, such handle grip covers are mass produced with ease and speed.

As shown in FIGS. 1, 2, the first conventional handle grip cover is an integrally formed tubular body 10 having an engagement opening 11 at one end and a plurality of recesses 12 defined on the inner wall thereof with a corresponding rib 13 formed between every two recesses 12. As the tubular body 10 is attached to the handle of a bicycle by way of the engagement opening 11, the ribs 13 are in direct contact with the surface of the handle with air chambers formed between the surface and the handle and the recesses 12.

Such a prior art handle grip cover 10 has the following disadvantages in practical use:

1. The recesses 12 are defined on the inner wall of the cover 10, making the mold releasing operation relatively hard and the production speed slow and commercially inefficient.

2. The recesses 12 defined on the inner wall are not able to effectively absorb the shock transmitted to the hands of a bicycle rider in practical operation.

Referring to FIGS. 3, 4, in the second prior art handle grip cover, the integrally formed hollow tubular body 20 has an engagement opening 21 at one end and is provided with a plurality of tiny hollow air chambers 22 on the wall of the tubular body 20. The tubular body 20 of the handle grip cover is attached to the handle of a bicycle via the engagement opening 21.

Such a prior art handle grip cover has the following disadvantages in practical use:

1. The spherical air chambers 22 are defined on the wall of the tubular body makes the production of the handle grip cover rather difficult, it must be performed in multiple processing steps to obtain a final product, causing the production speed slow and commercially inefficient.

2. The air chambers 22 formed on the wall of the tubular body are not effective in absorbing shock transmitted to the hands of a rider grasping the handles of a bicycle in practical use.

### SUMMARY OF THE INVENTION

Therefore, the primary object of the present invention is to provide an improved handle grip cover for use on a bicycle on the wall of which is equipped with a plurality of paired through holes perpendicular to the axial direction or an engagement opening thereof. Thereby a rider of a bicycle can hold the handle grip cover s with comfort as a result of the paired through holes being compressed with ease to absorb shocks in riding.

Another object of the present invention is to provide an improved handle grip cover which is an integrally formed hollow body having an engagement opening at one end and a plurality of paired through holes on the wall of the body perpendicular to the longitudinal direction thereof.

### BRIEF DESCRIPTION OF THE DRAWINGS

FIG. 1 is a longitudinal sectional diagram showing the first conventional handle grip cover;

FIG. 2 is a lateral sectional diagram of the first conventional handle grip cover;

FIG. 3 is a longitudinal sectional diagram showing the second conventional handle grip cover;

FIG. 4 is a lateral sectional diagram of the second conventional handle grip cover;

FIG. 5 is a perspective diagram of the handle grip cover of the present invention;

FIG. 6 is a longitudinal sectional diagram of the handle grip cover of the present invention;

FIG. 7 is a lateral sectional diagram thereof.

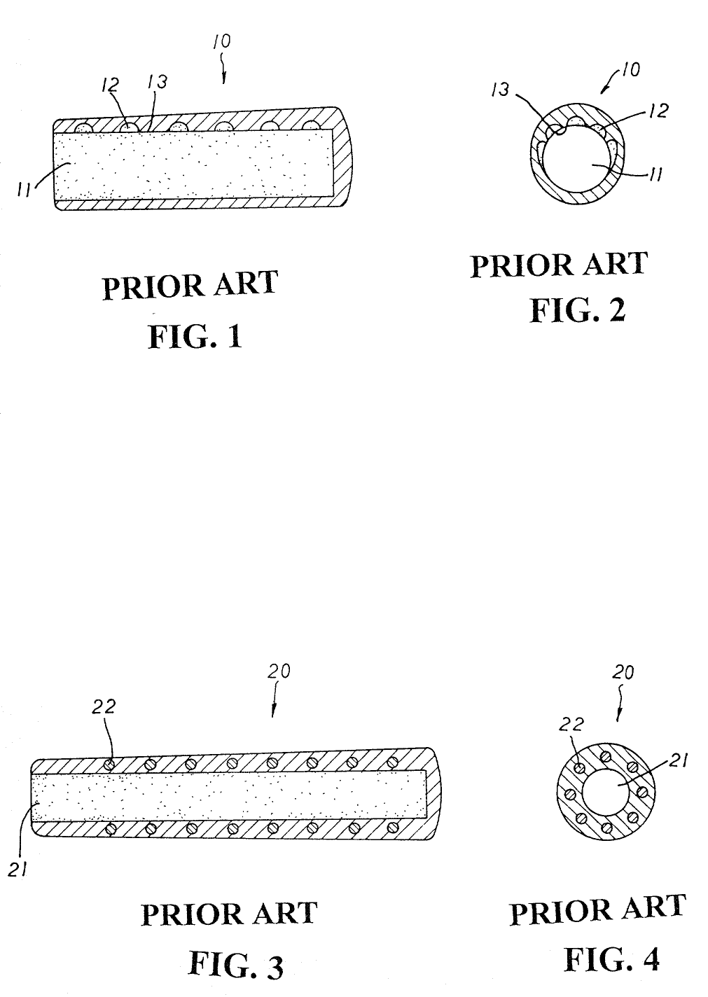

### DETAILED DESCRIPTION OF THE PREFERRED EMBODIMENTS

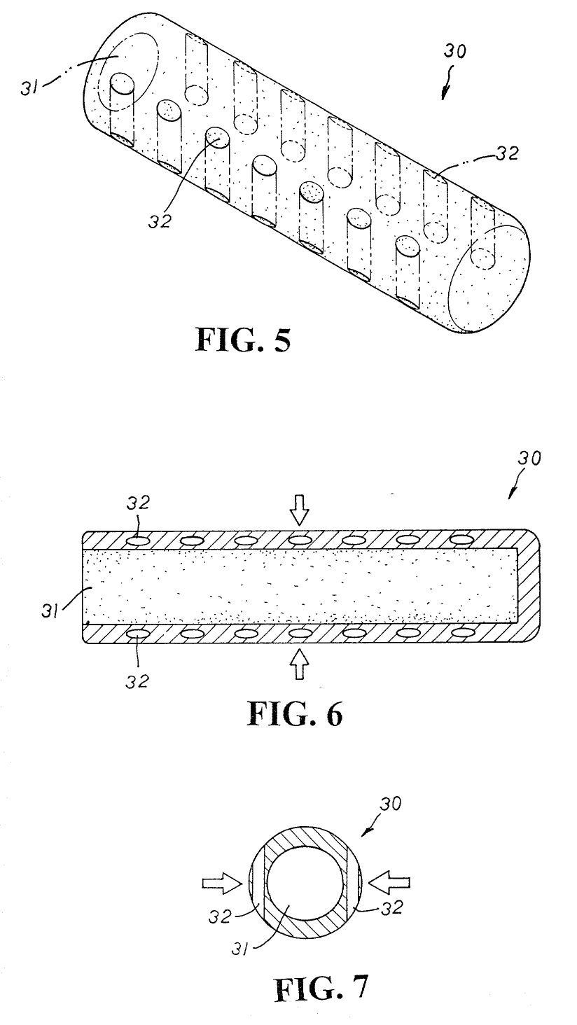

Referring to FIG. 5, the handle grip cover illustrated in a perspective manner is an integrally formed hollow body 30 of proper elasticity having a front engagement opening 31 at one end. On the wall defined along the longitudinally extended hollow body 30 are disposed a plurality of parallel paired tubular holes 32 that are normal to the axis of the engagement opening 31.

As shown in FIGS. 6, 7, the handle grip cover of the present invention is longitudinally attached to the handle of a bicycle via the engagement opening 31 with the parallel paired tubular holes 32 normal to the ground. In practical operation, the tubular holes 32 on the wall of the tubular hollow body 30 can effectively absorb the force exerted by the palm and fingers of a rider's hand as indicated by the hollow arrow in FIG. 7, so is the shock applied to the handle of the bicycle absorbed by t he flexible hollow holes 32, making the hands holding the handle of a bicycle feel comfortable.

I claim:

1. A handle grip cover for use on a bicycle comprising an integrally formed hollow tubular body of proper elasticity having a front engagement opening at one end for attachment of said cover to the handle of a bicycle wherein said handle grip cover is characterized by that on a wall defined along said longitudinally extended hollow body are disposed a plurality of tubular holes that are normal to the axis of said engagement opening whereby shock transmitted to the handles of a bicycle can be absorbed by said flexibly compressed tubular holes on the hollow tubular body.

2. The handle grip cover for use on a bicycle as claimed in claim 1 wherein said tubular holes on the wall of said hollow body are made in a parallel paired manner.
